(19) United States
(12) Patent Application Publication
(10) Pub. No.: US 2010/0033622 A1
(43) Pub. Date: Feb. 11, 2010

(54) Multiple description coding video transmission using de-interlacing mechanisms

(76) Inventors: Erwin Bellers, Fremont, CA (US); Mihaela Van Der Schaar, Los Angeles, CA (US)

Correspondence Address: PHILIPS INTELLECTUAL PROPERTY & STANDARDS, PO BOX 3001, BRIARCLIFF MANOR, NY, 10510-8001, US

(21) Appl. No.: 10/594,022

(22) PCT Filed: Mar. 23, 2005
(86) PCT No.: PCT/IB05/51004

§ 371 Date: Aug. 17, 2009

Related U.S. Application Data
(60) Provisional application No. 60/556,352, filed on Mar. 24, 2004.

(51) Int. Cl. H04N 7/01; H04N 7/26

(52) U.S. Cl. 348/448; 348/607; 375/240.27; 348/E07.003; 375/E07.073

(57) ABSTRACT

Multiple Description Coding (MDC) has been shown to be an effective technique for robust transmission of video data over networks including wireless systems and the Internet. A method is provided where the video signal (20) is interlaced and split into multiple streams before being encoded and transmitted over separate transmission channels (308, 310). At a receiver (320) side, de-interlacing algorithms may be applied and the streams are regrouped to form the original video signal (20). The use of interlacing and deinterlacing techniques improve the robustness of video transmission without having to modify existing equipment.

The present invention relates generally to the transmission of video sequences (20) over a network. More particularly, the present invention relates to methods of transmitting and receiving robust video over error prone channels of a network.

As communication over wireless systems and the Internet has become more predominant, ways to reliably send and receive video streams over such networks have been developed. Multiple description coding (MDC) is one technique that has been shown to be effective for such communications. MDC involves the separation of video streams into multiple correlated coded representations, or descriptions, of the video signal, and transmission of the representations on separate channels for error resilience. With this technique, an acceptable signal quality can be obtained using a subset of the descriptions, with the quality improving as the number of subsets received increases. One way of splitting the video streams is by separating the stream into odd and even frames and then coding the streams independently. When one of the streams is received, it can be decoded at half the frame rate. Due to the correlated nature of the video streams, intermediate frames that may become lost during transmission may be recovered using motion compensated error concealment techniques.

Examples of techniques using motion compensated error concealment are Multiple State Encoding, Video Redundancy Coding (VRC) and Multiple Description Motion Compensation (MDMC). Generally, a Multiple State Encoding system includes an encoder that receives a video stream and encodes the video into independently decodable packet streams by employing multiple state encoding with multiple states, and a receiver that receives and combines the multiple streams into a single stream and decodes the received stream to reconstruct the original video stream.

Referring to FIG. 1, a simplified block diagram of an existing VRC encoder is shown. Here, the video signal, consisting of a series of frames 10, is to be transmitted. The odd 10a and even 10b frames are separated and encoded using two standardized coders 12, and then the descriptions are transmitted over the network. In the event that a frame 10 is corrupted or lost in the transmission, the frame 10 can be reconstructed using a standardized decoder by interpolation from neighboring frames of the other data stream or description. Hence, the reconstruction is performed using purely temporal information, as no spatial information is available. Additionally, due to the signal being split and encoded, the temporal distance between the frames is relatively large, which will decrease the coding efficiency.

Implementing the MDMC technique will provide a system with better coding efficiency. Here, non-standardized coders/decoders are employed. Using MDMC two descriptions can be generated, where each includes coded information for alternating frames. Temporal predictors are used that allow the encoder to use both past even and odd frames while encoding. This creates a mismatch between the encoder and the decoder when only one description is received by the decoder at the receiver side of the network. This mismatch error is explicitly encoded to overcome the mismatch transmission error. With MDMC the coding parameters, such as temporal filters, can be adjusted to a desired trade-off between coding efficiency and error resilience. Thus, an MDMC system provides reasonable flexibility between coding efficiency and error resilience.

While the use of MDMC coding provides coding efficiency benefits over VRC schemes, MDMC coding requires non-standardized coders/decoders that are not present in existing video display equipment. Thus, there exists a need for a way to transmit video information over error prone networks in an efficient and error resilient manner using existing equipment.

The present invention satisfies the above described need. In accordance with principles of the present invention, an improved method for transmitting and receiving video signals is provided. At a transmitter side of a network, a progressive video sequence (20) is interlaced and the interlaced sequence is split into multiple streams. The multiple streams are encoded using encoders and then the streams are transmitted over independent channels of the network. Preferably the sequence is split into two streams of signals. At the receiver side of the network, the two streams are received and separately decoded. If there were no transmission errors, the decoded streams are regrouped into the original progressive video sequence (20). If however, there were transmission errors, de-interlacing algorithms are used to reconstruct the corrupted stream of signals.

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified block diagram of a prior art VRC encoder;

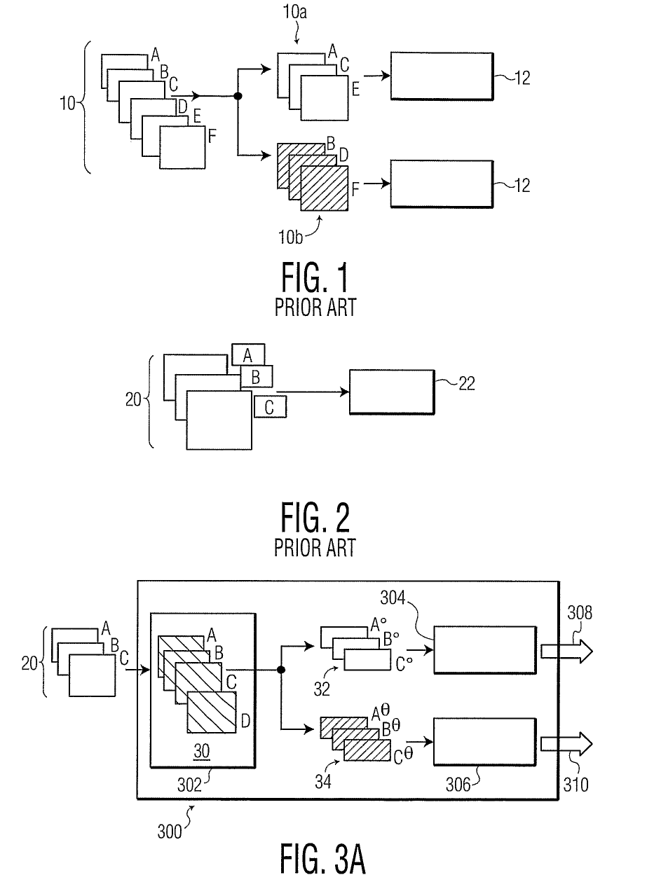

FIG. 2 is a simplified diagram illustrating the how progressive video signals are currently transmitted over networks;

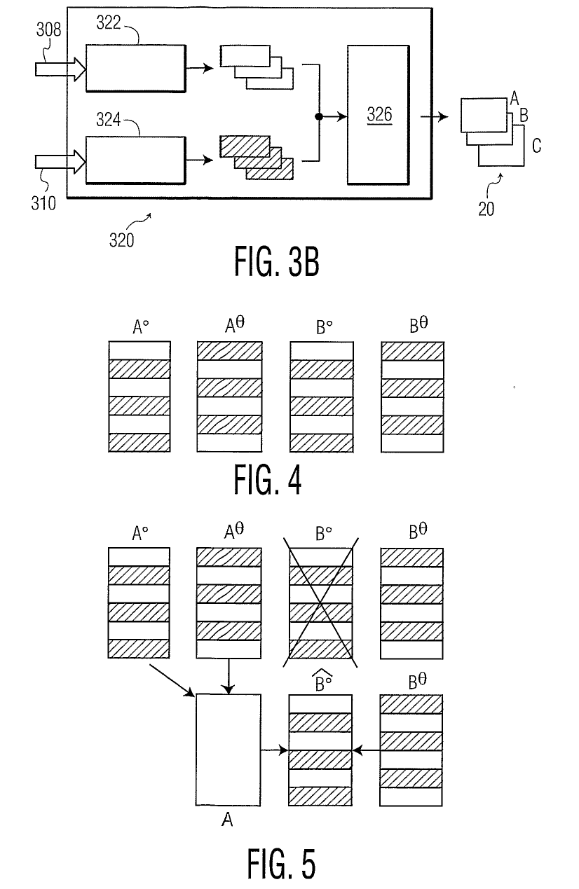

FIGS. 3A and 3B are simplified block diagrams illustrating a transmitter and receiver for communicating progressive video signals over networks in accordance with principles of the present invention;

FIG. 4 shows a representation of interlaced video signals in accordance with principles of the present invention; and

FIG. 5 shows the reconstruction of a lost or corrupted video image in accordance with principles of the present invention.

As most video images are now in digital format such as on DVDs, the video is often stored in progressive format. FIG. 2 shows a simplified block diagram representation of a video sequence 20, consisting of progressive pictures A, B, C, being encoded with a standardized video encoder 22, such as an MPEG-2 or MPEG-4 encoder, for transmission over a network.

Referring now to FIGS. 3A, 3B and 4, a device and method of transmitting the same video sequence 20 according to principles of the present invention will now be described. Each of the progressive pictures A, B and C of the video sequence 20 consists of odd and even fields (e.g. Ao, Ae, Bo, Be, Co, Ce). At the transmitter 300, the video signal 20 is interlaced with an interlacer 302. Interlacing involves vertically subsampling the pictures with a factor of two, by separating the odd scanning lines and the even scanning lines separately. This results in pictures containing only the odd scanning lines, hereinafter referred to the odd fields, and picture containing only the even scanning lines, hereinafter referred to the even fields, as shown in FIG. 4. Here, it is important to note that none of the original scanning lines is lost, i.e., the total number of scanning lines before and after the above described interlacing is performed, is identical. The interlaced signal 30 is then separated into a video stream of odd fields 32 and even fields 34. The video streams of odd and even fields are separately encoded with standardized MPEG-2/4 encoders 304, 306, creating two descriptions each having their own prediction vectors and residues after the encoding. The encoded descriptions are then transmitted over independent channels 308, 310 to a receiver 320.

At the receiver 320, both streams of encoded signals can be decoded using standardized MPEG-2/4 decoders 322, 324. If the streams are received and decoded with no transmission errors, the decoded streams are regrouped to form the original progressive video sequence 20.

However, if during transmission one of the streams got corrupted, or a field in the stream was lost, the present invention provides for a way to estimate the corrupt or missing information from the information that is correctly received. In accordance with principles of the present invention, a deinterlacer 326, employing standard de-interlacing techniques, can be used to estimate the corrupt or missing information. In general, de-interlacing can be viewed as the reverse process of interlacing. De-interlacing doubles the vertical resolution with respect to the interlaced video, and is also aimed at removing subsampling artifacts caused by the interlaced sampling of the video. For background information on de-interlacing, an overview and examples of de-interlacing techniques are described in G. de Haan and E. B. Bellers, “De-interlacing: an overview,” Proceedings of the IEEE, 86(9): 1839-1857, September 1998; and E. B. Bellers and G. de Haan, “De-interlacing: A key technology for scan rate conversion,” Elsevier Science book series Advances in Image Communications, vol. 9, September 2000. Many de-interlacing techniques currently exist, and many new ones are also being developed. A particular de-interlacing technique that can be used in accordance with the present invention is found in commonly owned U.S. Pat. No. 6,618,094 entitled “De-Interlacing Image Signals,” the contents of which is herein incorporated by reference in its entirety. Using this technique, at least three de-interlacing algorithms are applied to the video signal to obtain three de-interlaced video signals, where different majorities of the algorithms have certain strengths and no majority of the algorithms copies a single spatio-temporally neighboring pixel to the interpolated position. An order statistical filter may then be used to obtain a single output signal from the three de-interlaced signals.

FIG. 5 shows an example of how de-interlacing can be used in accordance with the present invention to reconstruct a non-received field of a picture. In this example, the odd field of picture B, Bo, was lost during the transmission. A de-interlacer is capable of reconstructing the lost Bo field based on information in the well received Be field and the regrouped A picture. Here, the de-interlacer capable of performing this reconstruction is a vertical temporal median filter that inherently switches between field insertion and line repetition. The interpolated samples are formed as the median value of the vertical neighbors and the temporal neighbor in the previous field. Thus, the missing field is interpolated from both spatial and temporal information.

While the above described preferred embodiment separates the video sequence into two streams of odd and even fields and generates two descriptions which are transmitted over two independent channels, other variations are possible. For instance, those skilled in the art would recognize that the video sequence can be split into a plurality of multiple streams, and the sequence can be split using other parameters.

The present invention provides advantages over the existing video transmission methods using multiple description coding. As described above, the method in accordance with the present invention uses de-interlacing techniques to reconstruct the progressive video in the event that an encoded field was corrupted during transmission. In this manner, both spatial as well as temporal information is used (in case of so-called motion adaptive or motion-compensated de-interlacing, whereas only spatial information is used in, for example, directional de-interlacers), thus a high quality reconstruction of the video can be achieved even when an unreliable transmission channel is used. Additionally, the error concealment can be achieved using existing post processing techniques in existing standardized decoders.

While the particular embodiments of the multiple description coding scheme as illustrated herein are fully capable of satisfying the needs and providing the advantages herein before stated, it is to be understood that many changes in construction and circuitry and widely differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

1. A method of transmitting a progressive video sequence comprising steps of: interlacing the video signal separating the video signal into multiple streams of video signals encoding the streams of video signals using a plurality of encoders and transmitting the separate streams of encoded signals to a network.

2. The method of claim 1 wherein the step of separating the video signal into multiple streams comprises separating the video signal into a stream of odd fields and a stream of even fields.

3. A method of receiving a progressive video sequence comprising the steps of: receiving separate streams of encoded signals from a network; decoding the separate streams of video signals using a plurality of decoders de-interlacing the video signals using a de-interlacer and regrouping the streams to form a progressive video sequence.

4. The method of claim 3 wherein the progressive video sequence comprises a series of video images and wherein the de-interlacer reconstructs a corrupted image based on one or multiple received neighboring images.

5. The method of claim 4 wherein the de-interlacer reconstructs the corrupted signal using temporal information from the received signals.

6. The method of claim 3, wherein the de-interlacer reconstructs the corrupted signal using spatial and temporal information from the received signals.

7. An improved method of receiving progressive video comprising: receiving the encoded streams at a receiver decoding the received streams of video; and reconstructing any portions of missing fields using de-interlacing algorithms.

8. The method of claim 7 wherein the de-interlacing algorithms employ spatial and temporal information from the received streams to reconstruct the missing fields.

9. The method of claim 8 wherein the step of separating the video comprises separating the video into a stream of odd fields and a stream of even fields wherein the odd fields comprise odd scanning lines of the video and the even fields comprise even scanning lines of the video.

10. A device for communicating a progressive video sequence to a network comprising: means for interlacing the video sequence means for splitting the interlaced sequence into multiple streams of signals; means for separately encoding the multiple streams of signals; and means for transmitting the multiple streams of encoded signals over independent channels.

11. A device for receiving a progressive video sequence from a network comprising: means for receiving multiple streams of encoded signals; means for separately decoding the multiple streams of signals; means for de-interlacing the decoded streams of signals; and means for regrouping the decoded streams into the video sequence.

12. The device of claim 11 wherein the means for de-interlacing uses temporal information to reconstruct a corrupted signal.

13. The device of claim 11, wherein the means for de-interlacing uses spatial and temporal information from the received corrupted signals.

14. The receiver of claim 11, wherein de-interlacing is performed to reconstruct a signal that was corrupted during its transmission over the network.
